(19) United States
(12) Patent Application Publication
(10) Pub. No.: US 2026/0332502 A1
(43) Pub. Date: Oct. 22, 2026

(54) POLICIES FOR CHANGING STATES IN COMMUNICATION INTERFACE LINKS

(71) Applicant: NVIDIA Corporation, Santa Clara, CA (US)

(72) Inventor: Eric Tyson, Santa Clara, CA (US)

(21) Appl. No.: 19/186,405

(22) Filed: Apr. 22, 2025

(51) Int. Cl. H04L 43/0894; H04L 12/54

(52) U.S. Cl. CPC H04L 43/0894; H04L 12/56; H04L 2012/5636

(57) ABSTRACT

A device connected to a link of a communication interface determines that a bandwidth utilization counter associated with the link satisfies a threshold criterion of multiple threshold criteria. The link is associated with a bandwidth state. A request to transition the link to another bandwidth state is sent to another device connected to the link.

### TECHNICAL FIELD

Aspects and embodiments of the present disclosure relate to communication interfaces in computing systems, and in particular to policies for changing states in communication interface links.

### BACKGROUND

A communication interface can enable data transfer between various components in a computing system, such as central processing units (CPUs), graphics processing units (GPUs), data processing units (DPUs), network interface controllers (NICs), data storage devices, etc.

### BRIEF DESCRIPTION OF THE DRAWINGS

Various embodiments in accordance with the present disclosure will be described with reference to the drawings, in which:

FIG. 1A is a block diagram of an example system architecture for a communication system, in accordance with an embodiment;

FIG. 1B is a block diagram of an example system architecture for a communication system, in accordance with an embodiment;

FIG. 1C is a block diagram of an example system architecture for a communication system, in accordance with an embodiment;

FIG. 1D is a block diagram of an example system architecture for a communication system, in accordance with an embodiment;

FIG. 2 is a block diagram of an example device in a communication system, in accordance with an embodiment;

FIG. 3 is a graph of an example bandwidth utilization counter value, in accordance with an embodiment;

FIG. 4 is a flow diagram of an example method for changing states in communication interface links, in accordance with an embodiment;

FIG. 5 is a block diagram illustrating an exemplary computer system, in accordance with an embodiment;

FIG. 7 is a block diagram of a computing system having a CPU and a GPU in a single integrated circuit, in accordance with an embodiment; and

FIG. 8 is a block diagram of a computing system having tensor core GPUs, in accordance with an embodiment.

### DETAILED DESCRIPTION

Aspects of the present disclosure relate to communication interfaces in computing systems. A communication interface can enable data transfer between various components in a computing system, such as central processing units (CPUs), graphics processing units (GPUs), data processing units (DPUs), network interface controllers (NICs), data storage devices, etc. A multi-lane communication interface can connect two devices using two or more lanes to form a link, where the lanes in aggregate can achieve higher bandwidth for the link than a single lane. Examples of multi-lane communication interfaces include Peripheral Component Interconnect Express (PCIe), Compute Express Link (CXL), NVLINK, InfiniBand, and Ethernet. Communication interfaces can be used in various applications ranging from data centers (e.g., high-performance computing, artificial intelligence, gaming, etc.) to consumer electronics (e.g., desktops, mobile devices).

Some communication interfaces can support changing link bandwidth to balance factors such as bandwidth needs, power consumption, and similar. For example, some multi-lane communication interfaces can support link width resizing, where the number of lanes used in a link can be dynamically reduced or increased as needed based on the above factors. Link bandwidth updates can be achieved via negotiation between the linked devices. However, communication interfaces may not provide standardized policies or communication methods for link bandwidth updates and may instead leave it to devices to determine when to initiate link bandwidth updates and whether to update resizing requests from linked devices. This can be particularly challenging for devices with varying applications and bandwidth needs. For example, a device used for one application can have more or less bandwidth needs than when used for another application. Furthermore, bandwidth needs can vary over time (e.g., seconds, minutes, hours, etc.) within a single application. As a result, a link can have excess bandwidth resulting in excessive power usage, or insufficient bandwidth resulting in communication bottlenecks.

Aspects of the present disclosure address these and other challenges by providing a dynamic policy for link width resizing based on bandwidth utilization. A device implementing this policy can include a bandwidth utilization counter (or other bandwidth utilization metric or bandwidth utilization parameter) for tracking bandwidth utilization in real time (e.g., as changes in bandwidth utilization occur). The counter can be incremented in proportion to traffic sent and/or received, indicating increased bandwidth needs. The counter can be decremented at another rate (e.g., fixed or variable, dependent or independent of traffic sent/received) such that when traffic is below the decrement rate, the counter decreases to indicate reduced bandwidth needs.

The policy can further include multiple thresholds corresponding to different link bandwidths. When the bandwidth utilization counter rises above one threshold, the device can negotiate an increased link bandwidth to support present bandwidth needs. When the bandwidth utilization counter falls below another threshold, the device can negotiate a decreased link bandwidth to save power. A gap between the first and second threshold can provide hysteresis that prevents frequent unnecessary link bandwidth updates. Furthermore, timing filters can ensure that the bandwidth utilization counter stays above/below a threshold for a fixed amount of time before a link bandwidth update is negotiated.

In an embodiment, the policy can be configured by software (including, e.g., firmware), such as a driver or an application. Various parameters such as the increment rate, the decrement rate, the thresholds, the filter values, and the link bandwidths can be optimized for different use cases, such as high-performance computing, artificial intelligence, and gaming use cases. Parameters can be configured explicitly or derived from usage patterns in various embodiments. Thus, computing systems and communication interfaces using these policy aspects can dynamically react to differing application and bandwidth needs by adjusting link bandwidth based on bandwidth utilization. Excessive power usage due to excess bandwidth and communication bottlenecks due to insufficient bandwidth can thus be mitigated or avoided.

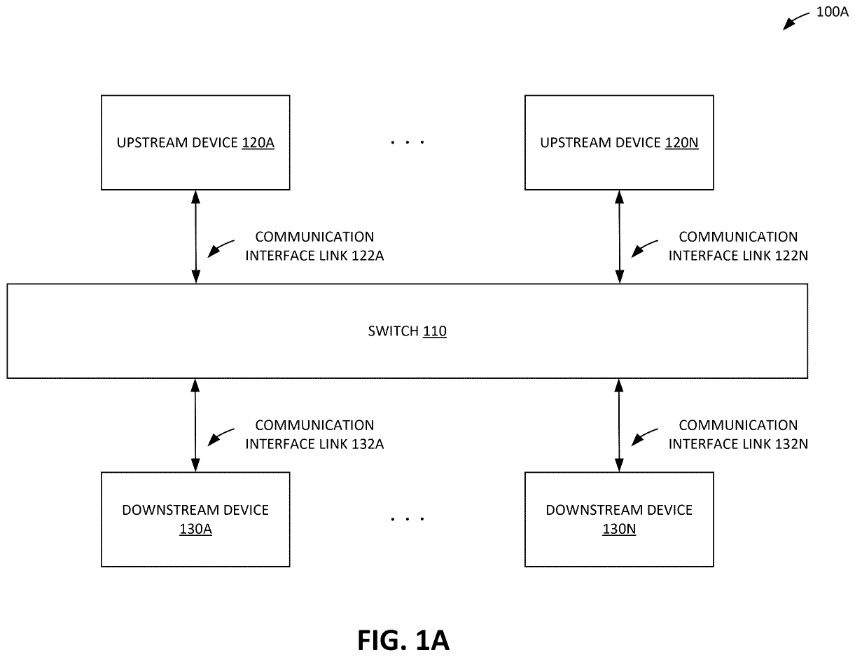

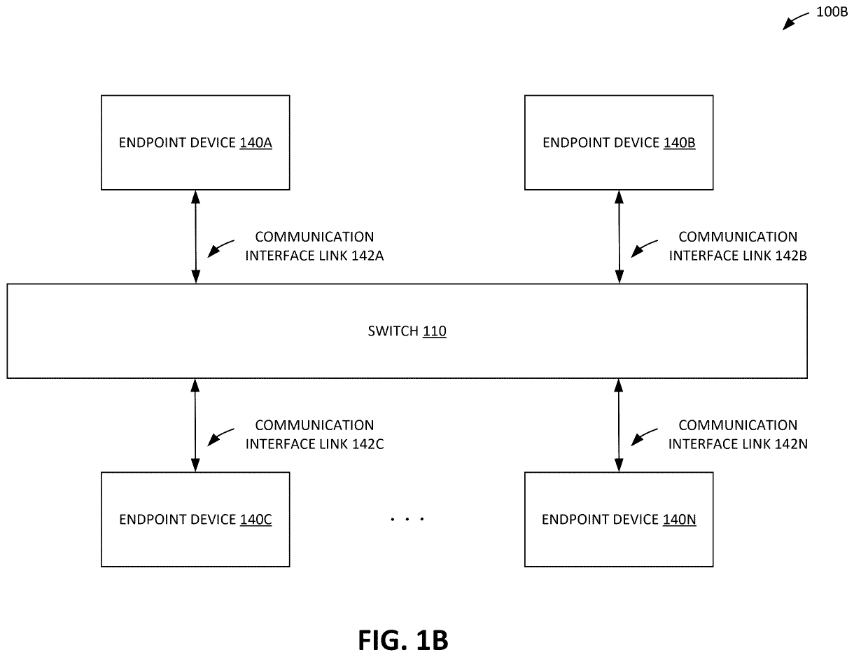

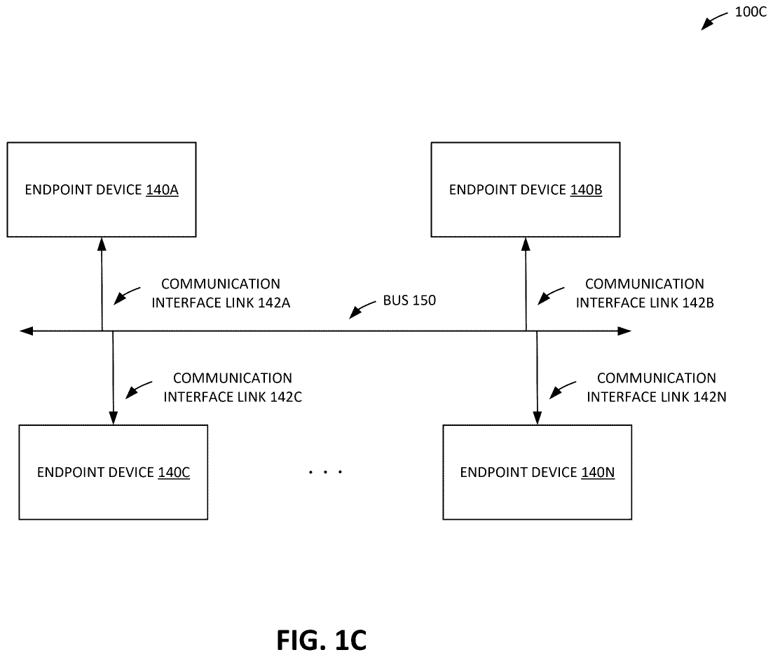

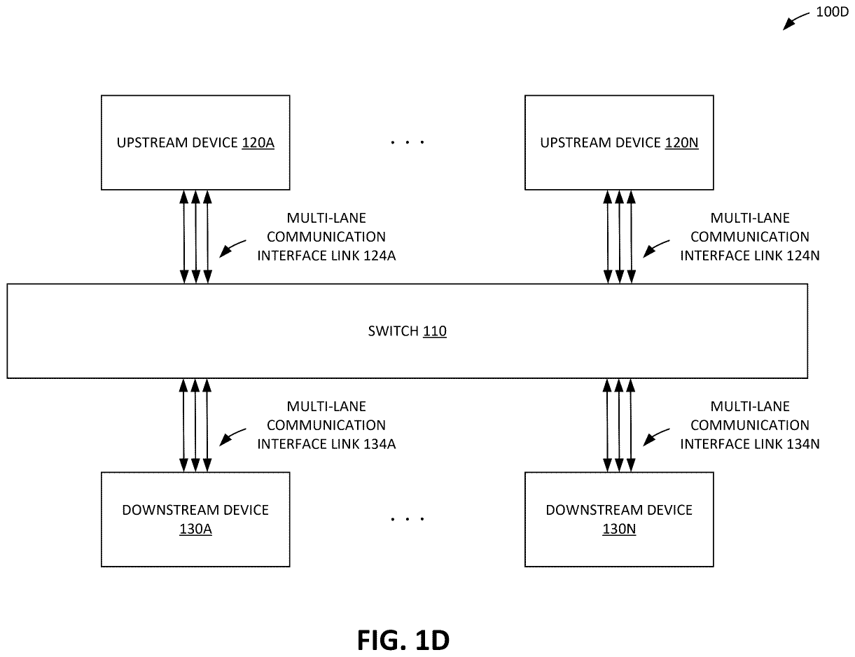

FIG. 1A is a block diagram of an example system architecture 100A for a communication system, in accordance with an embodiment. System architecture 100A (also referred to as “system” herein) includes switch 110, upstream devices 120A-N, and downstream devices 130A-N. System 100A further includes communication interface links 122A-N and 132A-N connecting the above components. In various embodiments, system 100A can include more or fewer components in different configurations than those depicted in FIG. 1A. For example, system 100A can include additional switches operating upstream or downstream from switch 110.

Communication system 100A is associated with a communication interface. The communication interface can define common media and/or protocols that devices and applications running thereon can use to communicate with each other. For example, the communication interface can define one or more layers of the Open Systems Interconnection (OSI) model, such as a physical layer, data link layer, application layer, and so on. Examples of communication interfaces that can be associated with communication system 100A include Peripheral Component Interconnect Express (PCIe), Compute Express Link (CXL), NVLINK, InfiniBand, Ethernet, Universal Serial Bus (USB), Inter-Integrated Circuit (I2C), Serial Peripheral Interface (SPI), and similar.

Devices participating in communication system 100A can be connected together via links compliant with the communication interface. A link can be a unidirectional or bidirectional channel for sending and/or receiving data between two devices and can be associated with underlying physical media and protocols defined by the communication interface. The performance of a link can be characterized in various ways. For example, link bandwidth can refer to how much data can traverse the link in a period of time, and link latency can refer to how much time it takes for data to traverse the link. Link error rate can refer to how often data is lost or corrupted on the link. In various embodiments, some of these performance characteristics can be tunable. For example, a link can be associated with a plurality of bandwidth states that can support more or less bandwidth depending on the needs of the connected devices/applications.

In various embodiments, the communication interface can support different types of devices, such as switches and endpoint devices. Switch 110 can be a device that routes data traffic between two or more devices connected to switch 110. In various embodiments, switch 110 can use look-up tables, addresses embedded in data packets, and/or other techniques to determine which device(s) to route traffic to. In various embodiments, a data packet received at switch 110 can be routable to any of the connected devices or to a subset of connected devices. For example, switch 110 can be a physical device that implements two or more virtual switches, which can each be associated with a respective tree of routable devices connected to switch 110.

Upstream devices 120A-N are endpoint devices that can perform a host or controller role in various embodiments. Upstream devices 120A-N can be connected to one or more downstream devices 130A-N via switch 110. Downstream devices 130A-N can perform a hosted or controlled role in various embodiments. Examples of upstream devices include PCIe root complexes or root ports thereof, and USB host-class devices. Examples of downstream devices include PCIe endpoint devices and USB device-class devices. In an embodiment, a communication system can have a single upstream device and one or more downstream devices.

FIG. 1B is a block diagram of an example system architecture 100B for a communication system, in accordance with an embodiment. System architecture 100B (also referred to as “system” herein) includes switch 110 and endpoint devices 140A-N. System 100B further includes communication interface links 142A-N connecting the above components. In various embodiments, system 100B can include more or fewer components in different configurations than those depicted in FIG. 1B. For example, system 100B can include additional switches operating upstream or downstream from switch 110. System 100B differs from system 100A in that there is no distinction between upstream and downstream devices; all devices can perform host/device, controller/controlled, sender/receiver, or other types of roles. An example communication system that can correspond to system 100B is an Ethernet system. In various embodiments, the device roles of systems 100A-B can be combined with aspects of one or more of systems 100C-D.

FIG. 1C is a block diagram of an example system architecture 100C for a communication system, in accordance with an embodiment. System architecture 100C (also referred to as “system” herein) includes bus 150 and endpoint devices 140A-N. System 100C further includes communication interface links 142A-N connecting the above components. In various embodiments, system 100C can include more or fewer components in different configurations than those depicted in FIG. 1C. For example, system 100C can include additional buses 150. System 100C differs from systems 100A-B in that there is no switch connected multiple devices; rather, all devices share the same physical or virtual media bus 150. An example communication system that can correspond to system 100C is an I2C system. In various embodiments, the bus configuration of system 100C can be combined with aspects of one or more of systems 100A, 100B, or 100D.

FIG. 1D is a block diagram of an example system architecture 100D for a communication system, in accordance with an embodiment. System architecture 100D (also referred to as “system” herein) includes switch 110, upstream devices 120A-N, and downstream devices 130A-N. System 100A further includes multi-lane communication interface links 124A-N and 134A-N connecting the above components. In various embodiments, system 100D can include more or fewer components in different configurations than those depicted in FIG. 1D. For example, system 100D can include additional switches operating upstream or downstream from switch 110. System 100D includes communication interface links can each have two or more lanes. An example communication system that can correspond to system 100D is a PCIe system. In various embodiments, the multi-lane communication interface links of system 100D can be combined with aspects of one or more of systems 100A-C.

Multi-lane communication interface links 124A-N can each have two or more lanes for sending and/or receiving traffic, and the number of active lanes (also referred to as “link width”) can be configurable in various embodiments. For example, multi-lane communication interface link 124A can be configured with one active lane, while multi-lane communication interface link 124B can be configured with four active lanes. In another example, multi-lane communication interface link 124A can transition from one active lane to four active lanes at a point in time. The bandwidth characteristic described above can refer to the overall bandwidth of the link, while a lane bandwidth characteristic can refer to the bandwidth of a single lane. In a multi-lane communication interface link, the link bandwidth can be the sum of the individual lane bandwidths. As described above, some embodiments of communication systems can support tunable link bandwidths, which in systems such as system 100D can include changing the link width (e.g., one to four) or changing the bandwidth of individual lanes (e.g., low bandwidth to high bandwidth). In an embodiment, resizing or changing a link bandwidth can include activating or deactivating one or more lanes.

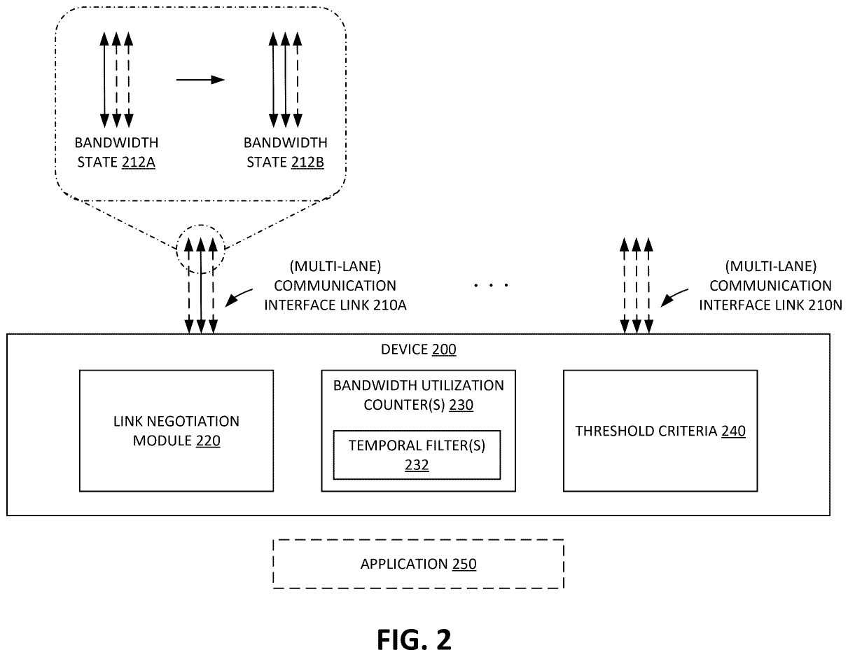

FIG. 2 is a block diagram of an example device 200 in a communication system, in accordance with an embodiment. In an embodiment, device 200 can be one of switch 110 or devices 120A-N, 130A-N, or 140A-N of FIGS. 1A-D. Device 200 is connected to one or more additional devices via one or more communication interface links 210A-N. Communication interface links 210A-N can be single-lane or multi-lane links in various embodiments. Device 200 includes link negotiation module 220, bandwidth utilization counter(s) 230, and threshold criteria 240. In various embodiments, device 200 can include more or fewer components than those depicted in FIG. 2. For example, device 200 can store additional parameters such as increment and decrement rates. Device 200 can be a PCIe device, an Ethernet device, a USB device, or other type of device in various embodiments.

Link negotiation module 220 can communicate with a connected device to configure the connecting link and can implement various protocols to do so. Link negotiation module 220 can be used to initialize a link or update link parameters. For example, link negotiation module 220 can negotiate an updated bandwidth state. In a single-lane or multi-lane communication interface link, an updated bandwidth state can be a transition from a low-bandwidth state to a high-bandwidth state or vice versa. In a multi-lane communication interface link, an updated bandwidth state can be a change in link width, as depicted in bandwidth states 212A-B (a transition from one lane to two lanes).

Bandwidth utilization counter(s) 230 can be hardware (e.g., registers) or software (e.g., counter variables) components that can be used to track bandwidth utilization on respective links. In various embodiments, each of links 210A-N can be associated with one or more bandwidth utilization counters, and each of bandwidth utilization counter(s) 230 can be associated with one or more links. In various embodiments, bandwidth utilization counter(s) 230 can be other types of bandwidth utilization metrics or bandwidth utilization parameters and associated hardware/software components.

Bandwidth utilization counter(s) 230 can be incremented or decremented at respective increment and decrement rates. Different types of increment and decrement rates can be used. In an embodiment, a fixed increment or decrement rate can be used. Bandwidth utilization counter(s) 230 can be incremented or decremented a number of counts per unit time or per unit time since last data transfer based on the fixed increment or decrement rate. In an embodiment, an increment or decrement rate based on link bandwidth or data transfer can be used. Bandwidth utilization counter(s) 230 can be incremented or decremented a number of counts per unit data transferred across the link, per unit change in data rate, per unit time since a previous transfer, or similar. Various embodiments can combine the above and other types of increment and decrement rates. For example, in an embodiment, an increment rate can be proportional to units of data transferred, and a decrement rate can be proportional to bandwidth (e.g., current or past bandwidth). In another example, an increment rate can be based on a combination of data transfer rate and bandwidth (e.g., current or past bandwidth), and a decrement rate can be based on a combination of time and bandwidth (e.g., fixed rate per unit time per unit bandwidth).

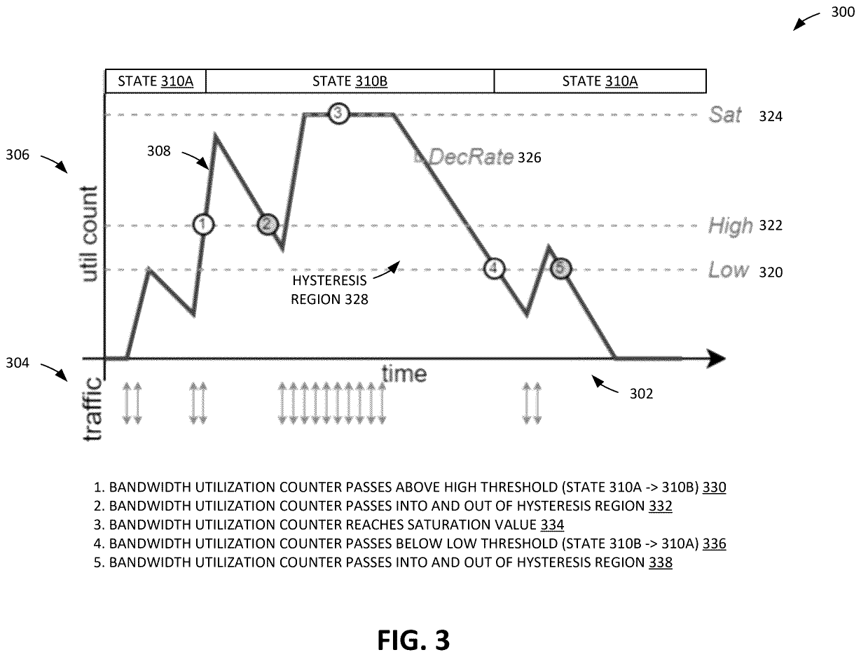

Threshold criteria 240 include one or more threshold criteria for bandwidth utilization counter(s) 230. A threshold criterion can be a counter value that is satisfied when a bandwidth utilization counter meets or passes above or below the threshold criterion. When a bandwidth utilization counter satisfies a threshold criterion, the associated link can be transitioned to another bandwidth state using link negotiation module 220. For example, when a bandwidth utilization counter passes above a threshold criterion, the associated link can be transitioned to a higher bandwidth (e.g., increased link width). When the utilization counter passes below a threshold criterion, the associated link can be transitioned to a lower bandwidth. In an embodiment, multiple threshold criteria can be chosen to create one or more hysteresis regions to prevent frequent unnecessary bandwidth transitions, as described with reference to FIG. 3. In an embodiment, a threshold criterion can be a saturation threshold, as described with reference to FIG. 3.

In an embodiment, threshold criteria 240 and bandwidth utilization counter(s) 230 can be used by link negotiation module 220 to determine whether to accept or reject a remote bandwidth change request from a device on the other side of the link. For example, link negotiation module can determine to reject a request to switch to a lower bandwidth state if bandwidth utilization counter(s) satisfy (e.g., exceed) a high threshold criterion. In an embodiment, separate bandwidth utilization counter(s) 230 and/or threshold criteria 240 can be used for initiating requests and determining how to respond to received requests. In an embodiment, request initiation and response actions can be based on the same bandwidth utilization counter(s) 230 and/or threshold criteria 240.

Bandwidth utilization counter(s) 230 can include temporal filters 232, which can similarly be used to prevent frequent unnecessary bandwidth transitions. A temporal filter can ensure that a bandwidth utilization counter remains above or below a threshold criterion for a fixed or variable amount of time before a link bandwidth transition is initiated.

In an embodiment, various components of device 200 can be configurable. For example, threshold criteria 240, temporal filter(s) 232, increment and decrement rates, and/or bandwidth states 212A-B can be configured for different use cases. Components of device 200 can be configured in hardware or software. For example, device 200 can be configured by a software driver or application, such as application 250. Examples of applications that can configure device 200 include high-performance computing (HPC) applications, artificial intelligence (AI) applications, gaming applications, and similar. In an embodiment, two or more applications of the same type (e.g., two HPC applications) can each provide different configuration parameters, which may or may not be applied at the same time. In an embodiment, device 200 can be configured using an application programming interface (API), such as an API provided by a device driver. In an embodiment, device 200 can be configured using configuration straps, read-only memory, or another stored configuration, which can be unique to a product line (e.g., SKU) or individual product (e.g., serial number). In an embodiment, an operating system or system management software can configure a device driver to be in a mode (of one or more modes) to tune the system for various needs.

FIG. 3 is a graph 300 of an example bandwidth utilization counter value 308, in accordance with an embodiment. Graph 300 depicts time on x-axis 302 and traffic on lower y-axis 304. The traffic depicted on lower y-axis 304 can be, for example, unidirectional or bidirectional data sent or received at a device (e.g., device 200) over a link (e.g., link 210A). Graph 300 further depicts bandwidth utilization count on upper y-axis 306. Bandwidth utilization count can be a unitless value. In an embodiment, bandwidth utilization counter value 308 is associated with bandwidth utilization counter(s) 230. Graph 300 furth depicts link bandwidth states 310A-B for different times at the uppermost section of the graph. Bandwidth states 310A-B can be bandwidth states 212A-B of FIG. 2.

Bandwidth utilization counter value 308 can be incremented and decrement at various rates and in response to various conditions. In the example depicted in FIG. 3, bandwidth utilization counter value 308 increases in response to traffic (on lower y-axis 304) at a rate proportional to the volume of traffic observed. The increment rate can thus be specified in units of counts per byte or similar units (e.g., kilobytes, DWORDS, etc.). In another example, utilization counter value 308 increases at a rate proportional to the rate of traffic observed (e.g., units of counts per kilobyte per second). In the example depicted in FIG. 3, bandwidth utilization counter value 308 decreases at a fixed decrement rate 326 (e.g., counts per second or similar units). In various embodiments, fixed rates can similarly be used for increment rates, and proportional rates can similarly be used for decrement rates.

Graph 300 further depicts threshold criteria 320 (low threshold criterion) and 322 (high threshold criterion). Threshold criteria 320-322 can be threshold criteria 240 of FIG. 2. Various embodiments can include fewer or more threshold criteria than depicted in FIG. 3.

Graph points 330-338 depict events associated with threshold criteria 320-322 and states 310A-B. Prior to graph point 330, the link is in bandwidth state 310A, and bandwidth utilization counter value 308 is below high threshold criterion 322. During this time, bandwidth utilization counter value 308 passes above and below low threshold criterion 320, which has no effect on the link bandwidth state. At graph point 330, bandwidth utilization counter value 308 satisfies and passes above high threshold criterion 322, which can cause a transition of the link bandwidth state from state 310A to 310B. At graph point 332, bandwidth utilization counter value 308 passes below high threshold criterion 322, but does not satisfy or pass below low threshold criterion 320. This region in between threshold criteria can be referred to as a hysteresis region (e.g., hysteresis region 328). In hysteresis region 328, the link remains in the same bandwidth state (e.g., state 310B) because the relevant threshold criterion (low threshold criterion 320 in the depicted case) has not been satisfied. Hysteresis regions can be advantageous to prevent unnecessary frequent switching of link bandwidth states. In various embodiments, one or more hysteresis regions can be present, or hysteresis regions can be absent (e.g., thresholds 320-322 can be at the same value or can be the same threshold).

In an embodiment, a system can include a saturation parameter (e.g., saturation value 324) for bandwidth utilization count. Saturation value 324 can be a maximum value of a bandwidth utilization counter or can be set to a lower value than the maximum counter value in various embodiments. As depicted at graph point 334, bandwidth utilization counter value 308 no longer increments once reaching saturation value 324, despite additional traffic depicted in lower y-axis 304. In an embodiment, a system can include a lower saturation parameter (not depicted) at which bandwidth utilization counter value 308 no longer decrements. Saturation parameters can be advantageous to provide more responsive link bandwidth state changes and prevent excessive or runaway counter values. For example, a saturation parameter can be used to control how much the system's memory of the current state factors into the readiness of the system to switch bandwidth states.

At graph point 336, bandwidth utilization counter value 308 satisfies/passes below lower threshold criterion 320, causing a transition of the link to bandwidth state 310A, analogous to the transition at graph point 330. At graph point 338, bandwidth utilization counter value 308 passes into and out of the hysteresis region without any change in link bandwidth state, analogous to graph point 332.

In an embodiment, a temporal filter can be used to ensure that bandwidth utilization counter value 308 satisfies a threshold criterion for a fixed or variable amount of time before a link bandwidth state change is initiated. In an example related to FIG. 3, a temporal filter can have a wait time value less than the distance between graph points 330 and 332. During this time, bandwidth utilization counter value 308 continuously satisfies high threshold criterion 322, and thus a link bandwidth state change can be initiated before graph point 332 (e.g., the change from state 310A to 310B shifts from graph point 330 to before graph point 332). In another example, the temporal filter can have a wait time value equal to or greater than the distance between graph points 330 and 332. During this time, bandwidth utilization counter value 308 initially satisfies high threshold criterion 322, but subsequently drops below high threshold criterion 322, and thus a link bandwidth state change would not be initiated. The temporal filter would reset again shortly after graph point 332 when bandwidth utilization counter value 308 rises above high threshold criterion 322. The change from state 310A to 310B thus shifts approximately to or after graph point 334.

In various embodiments, more or fewer threshold criteria than depicted in FIG. 3 can be used. For example, a third threshold criterion above high threshold criterion 322 can be associated with a state change to state 310C (not depicted). High threshold criterion 322 can be used in a manner similar to low threshold criterion 320 to return the link bandwidth state to state 310B.

In various embodiments, threshold criteria can be updated or changed based on various factors. For example, a device can receive new parameters that include threshold criteria updates. In another example, a threshold criterion, once satisfied, can be updated to a new value. For example, once high threshold criterion 322 is satisfied, it can be updated to a higher threshold criterion corresponding to a transition to link bandwidth state 310C (not depicted).

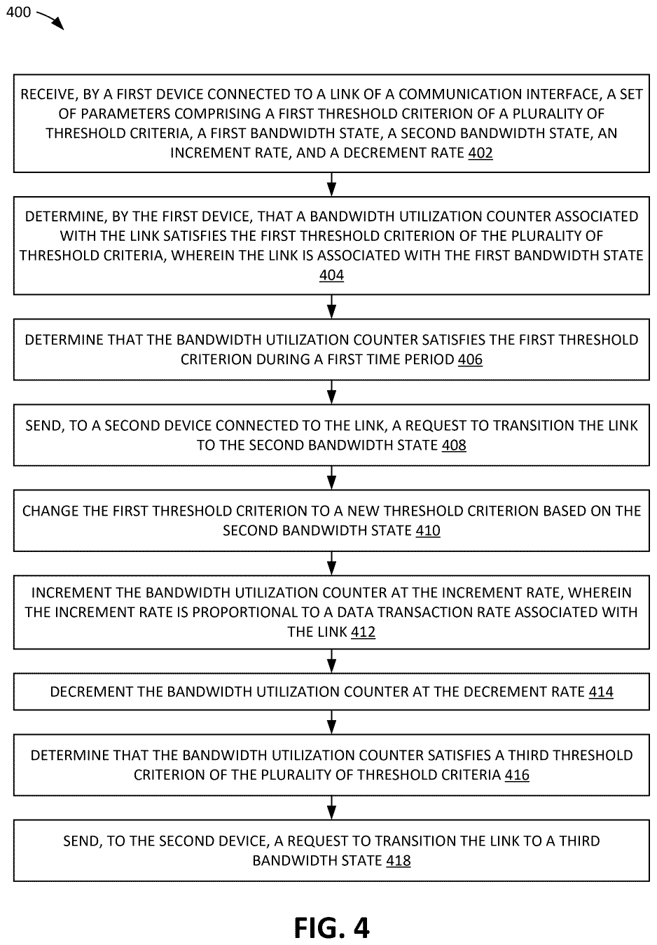

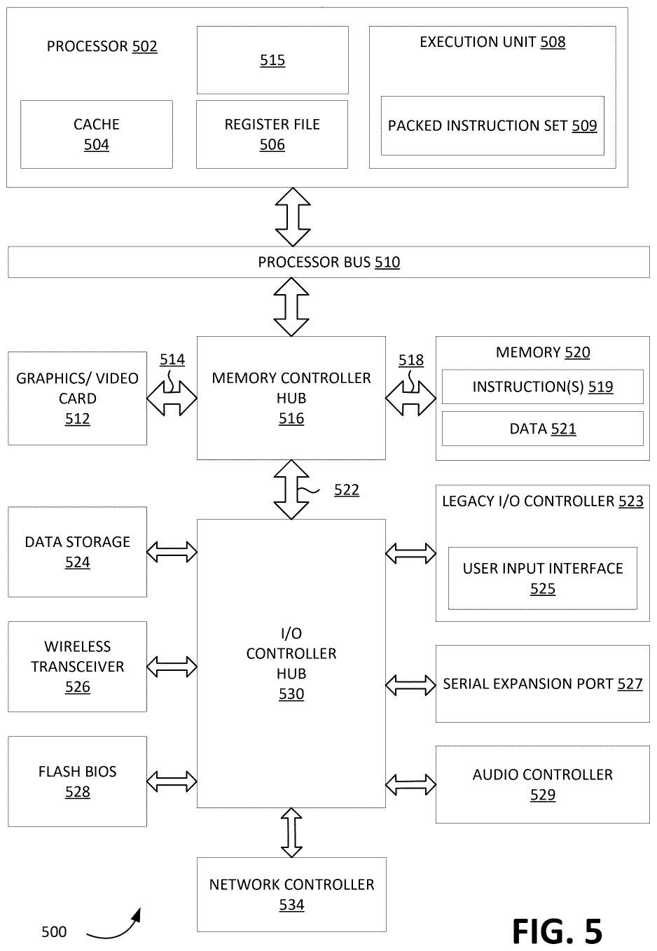

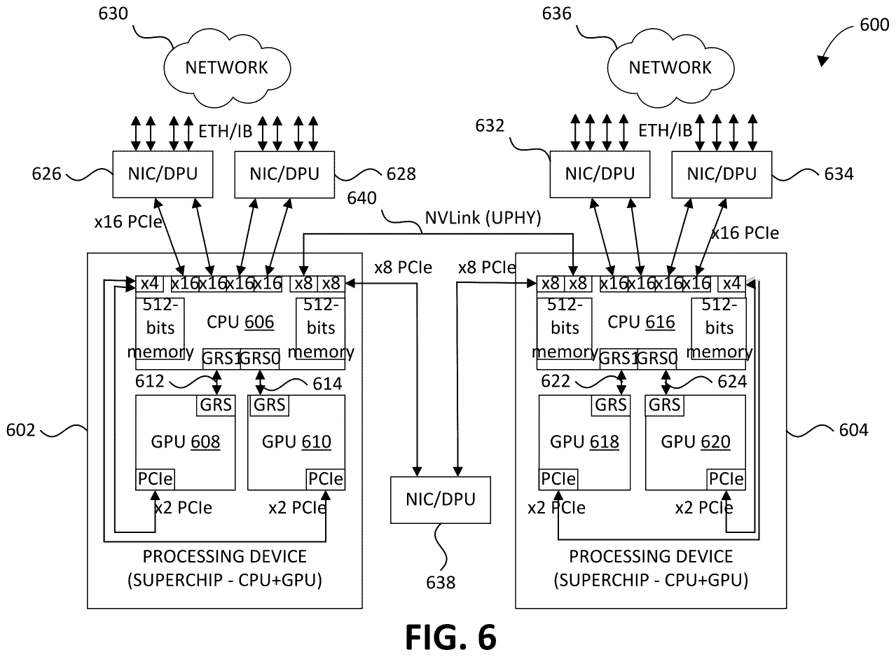

FIG. 4 is a flow diagram of an example method 400 for changing states in communication interface links, in accordance with at least one embodiment. Method 400 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 400. Method 400 can also be associated with a set of instructions stored on a non-transitory computer-readable medium (e.g., magnetic or optical disk, etc.). The instructions, when executed by a processing device, can cause the processing device to perform operations comprising the blocks of method 400. In at least one embodiment, method 400 is performed by one or more of switch 110 or devices 120A-120N, 130A-N, or 140A-N of FIGS. 1A-D, or components thereof. In at least one embodiment, method 400 is performed by computing system 500 of FIG. 5. In some embodiments, blocks depicted in FIG. 4 could be performed simultaneously or in a different order than depicted. Various embodiments can include additional blocks not depicted in FIG. 4 or a subset of blocks depicted in FIG. 4.

At block 402, processing logic of a first device connected to a link of a communication interface receives a set of parameters comprising a first threshold criterion of a plurality of threshold criteria, a first bandwidth state, a second bandwidth state, an increment rate, and a decrement rate. The first device can be switch 110, devices 120A-120N, 130A-N, or 140A-N, or device 200. The link of the communication interface can be one of communication interface links 122A-N, 124A-N, 132A-N, 142A-N, or 210A-N. The plurality of threshold criteria can be threshold criteria 240. The first and second bandwidth states can be bandwidth states 212A-B or 310A-B. The decrement rate can be decrement rate 326. In an embodiment, the received increment rate is a function of one or more increment parameters, and the received decrement rate is a function of one or more decrement parameters. For example, the increment rate can be a function of data transfer volume or data transfer rate (e.g., a variable increment rate) and the decrement rate can be a function of time (e.g., a fixed decrement rate), or vice versa. In another example, an increment or decrement rate can be a function of a current or past link bandwidth state. In an embodiment, the set of parameters is associated with an application, such as one or more of a high-performance computing (HPC) application, an artificial intelligence (AI) application, or a gaming application.

At block 404, the processing logic determines that a bandwidth utilization counter associated with the link satisfies the first threshold criterion of the plurality of threshold criteria, wherein the link is associated with the first bandwidth state. As described with reference to FIG. 3, the bandwidth utilization counter can satisfy the first threshold criterion by meeting or passing above/below the threshold criterion. For example, the first threshold criterion can be high threshold criterion 322, which is satisfied at graph point 330. The first bandwidth state can be state 310A, for example.

At block 406, the processing logic determines that the bandwidth utilization counter satisfies the first threshold criterion during a first time period. The first time period can be associated with a temporal filter as described with reference to FIGS. 2-3. Temporal filters can be used for both low-to-high transitions and high-to-low transitions in various embodiments.

At block 408, the processing logic sends, to a second device connected to the link, a request to transition the link to the second bandwidth state. The request to transition the link to the second bandwidth state can be sent by link negotiation module 220. The second bandwidth state can be bandwidth state 212B and/or 310B.

In an embodiment, the communication interface is a multi-lane communication interface, such as a PCIe communication interface. The first bandwidth state can correspond to a first link width (e.g., m lanes), and the request to transition the link to the second bandwidth state can be a request to resize the first link width to a second link width (e.g., n lanes). The second link width can have more or fewer active lanes than the first link width in various embodiments.

In an embodiment, the plurality of threshold criteria includes a second threshold criterion that pertains to a transition from the second bandwidth state to the first bandwidth state. A difference between the first threshold criterion and the second threshold criterion can correspond to a hysteresis region. The bandwidth utilization counter can satisfy the first threshold criterion responsive to passing a first threshold value associated with the first threshold criterion subsequent to passing a second threshold value associated with the second threshold criterion. For example, referring to FIG. 3, bandwidth utilization counter value 308 passes low threshold criterion 320 followed by passing high threshold criterion 322. In an embodiment, the thresholds can be equal or can be the same threshold, and the hysteresis region can thus be of size zero.

At block 410, the processing logic changes the first threshold criterion to a new threshold criterion based on the second bandwidth state. For example, the first threshold criterion can be increased to a higher link utilization than the link utilization associated with the second bandwidth state. Upon satisfying the new threshold criterion, the system can transition to a third bandwidth state and update the first threshold criterion again. In an embodiment, other threshold criteria can similarly be updated to new threshold criteria based on the second bandwidth state.

At block 412, the processing logic increments the bandwidth utilization counter at the increment rate, wherein the increment rate is proportional to a data transaction rate associated with the link. In various embodiments, the increment rate can alternatively be fixed or be proportional to other quantities, as previously described.

At block 414, the processing logic decrements the bandwidth utilization counter at the decrement rate. In various embodiments, the decrement rate can be a fixed rate or can be proportional to various quantities, as previously described.

At block 416, the processing logic determines that the bandwidth utilization counter satisfies a third threshold criterion of the plurality of threshold criteria. In an embodiment, the third threshold criterion can be the new threshold criterion of block 410. In an embodiment, the third threshold criterion can be a different threshold criterion of threshold criteria 240 existing simultaneously with the first and second threshold criteria.

At block 418, the processing logic sends, to the second device, a request to transition the link to a third bandwidth state. The request can be similar to the request described with reference to block 408.

FIG. 5 is a block diagram illustrating an exemplary computer system, which may be a system with interconnected devices and components, a system-on-a-chip (SOC) or some combination thereof 500 formed with a processor that may include execution units to execute an instruction, according to at least one embodiment. In at least one embodiment, computer system 500 may include, without limitation, a component, such as a processor 502 to employ execution units including logic to perform algorithms for process data, in accordance with present disclosure, such as in embodiment described herein. In at least one embodiment, computer system 500 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 500 may execute a version of WINDOWS′ operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 500 may include, without limitation, processor 502 that may include, without limitation, one or more execution units 508 to perform machine learning model training and/or inferencing according to techniques described herein. In at least one embodiment, computer system 500 is a single processor desktop or server system, but in another embodiment computer system 500 may be a multiprocessor system. In at least one embodiment, processor 502 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 502 may be coupled to a processor bus 510 that may transmit data signals between processor 502 and other components in computer system 500.

In at least one embodiment, processor 502 may include, without limitation, a Level 1 (“L1”) internal cache memory (“cache”) 504. In at least one embodiment, processor 502 may have a single internal cache or multiple levels of internal cache. In at least one embodiment, cache memory may reside external to processor 502. Other embodiments may also include a combination of both internal and external caches depending on particular implementation and needs. In at least one embodiment, register file 506 may store different types of data in various registers including, without limitation, integer registers, floating point registers, status registers, and instruction pointer register.

In at least one embodiment, execution unit 508, including, without limitation, logic to perform integer and floating-point operations, also resides in processor 502. In at least one embodiment, processor 502 may also include a microcode (“ucode”) read-only memory (“ROM”) that stores microcode for certain macro instructions. In at least one embodiment, execution unit 508 may include logic to handle a packed instruction set 509. In at least one embodiment, by including packed instruction set 509 in an instruction set of a general-purpose processor 502, along with associated circuitry to execute instructions, operations used by many multimedia applications may be performed using packed data in a general-purpose processor 502. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 508 may also be used in microcontrollers, embedded processors, graphics devices, DSPs, and other types of logic circuits. In at least one embodiment, computer system 500 may include, without limitation, a memory 520. In at least one embodiment, memory 520 may be implemented as a Dynamic Random Access Memory (“DRAM”) device, a Static Random Access Memory (“SRAM”) device, flash memory device, or other memory device. In at least one embodiment, memory 520 may store instruction(s) 519 and/or data 521 represented by data signals that may be executed by processor 502.

In at least one embodiment, system logic chip may be coupled to processor bus 510 and memory 520. In at least one embodiment, system logic chip may include, without limitation, a memory controller hub (“MCH”) 516, and processor 502 may communicate with MCH 516 via processor bus 510. In at least one embodiment, MCH 516 may provide a high bandwidth memory path 518 to memory 520 for instruction and data storage and for storage of graphics commands, data and textures. In at least one embodiment, MCH 516 may direct data signals between processor 502, memory 520, and other components in computer system 500 and to bridge data signals between processor bus 510, memory 520, and a system I/O 522. In at least one embodiment, system logic chip may provide a graphics port for coupling to a graphics controller. In at least one embodiment, MCH 516 may be coupled to memory 520 through a high bandwidth memory path 518 and graphics/video card 512 may be coupled to MCH 516 through an Accelerated Graphics Port (“AGP”) interconnect 514.

In at least one embodiment, computer system 500 may use system I/O 522 that is a proprietary hub interface bus to couple MCH 516 to I/O controller hub (“ICH”) 530. In at least one embodiment, ICH 530 may provide direct connections to some I/O devices via a local I/O bus. In at least one embodiment, local I/O bus may include, without limitation, a high-speed I/O bus for connecting peripherals to memory 520, chipset, and processor 502. Examples may include, without limitation, an audio controller 529, a firmware hub (“flash BIOS”) 528, a wireless transceiver 526, a data storage 524, a legacy I/O controller 523 containing user input and keyboard interfaces 525, a serial expansion port 527, such as Universal Serial Bus (“USB”), and a network controller 534, which may include in some embodiments, a data processing unit. Data storage 524 may comprise a hard disk drive, a floppy disk drive, a CD-ROM device, a flash memory device, or other mass storage device.

In at least one embodiment, FIG. 5 illustrates a system, which includes interconnected hardware devices or “chips,” whereas in other embodiments, FIG. 5 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 500 are interconnected using compute express link (CXL) interconnects. In at least one embodiment, system 500 can correspond to systems 100A-D or components thereof, such as devices 120A-N, 130A-N, 140A-N, 200, and connecting links 122A-N, 124A-N, 132A-N, 142A-N, and 210A-N.

FIG. 6 is a block diagram of a computing system 600 having two processing devices coupled to each other and multiple networks according to at least one embodiment. The computing system 600 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 600. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 600 highly suitable for demanding applications that require significant processing power, such as artificial intelligence (AI), machine learning (ML), and data-intensive computing, while ensuring robust connectivity and scalability across various networked environments. The integrated circuits of the computing system 600 can include one or more CPUs and one or more GPUs. An example architecture of a multi-GPU architecture is illustrated in FIG. 6.

As illustrated in FIG. 6, the computing system 600 includes a processing device 602 with a multi-GPU architecture. In particular, the processing device 602 includes a CPU 606, a GPU 608, and a GPU 610. The CPU 606 can be coupled to the GPU 608 via an die-to-die (D2D) or chip-to-chip (C2C) interconnect 612, such as a Ground-Referenced Signaling interconnect (GRS interconnect). The CPU 606 can be coupled to the GPU 610 via a D2D or C2C interconnect 614. The CPU 606 can also couple to the GPU 608 and GPU 610 via PCIe interconnects. The CPU 606 can be coupled to one or more network interface cards (NICs) or data processing units (DPUs), which are coupled to one or more networks. For example, as illustrated in FIG. 6, the CPU 606 is coupled to a first NIC/DPU 626, which is coupled to a network 630. The CPU 606 is also coupled to a second NIC/DPU 628, which is coupled to the network 630. The NIC/DPU 626 and NIC/DPU 628 can be coupled to the network 630 over Ethernet (ETH) or InfiniBand (IB) connections.

The computing system 600 also includes a processing device 604 with a multi-GPU architecture. In particular, the processing device 604 includes a CPU 616, a GPU 618, and a GPU 620. The CPU 616 can be coupled to the GPU 618 via an D2D or C2C interconnect 622. The CPU 616 can be coupled to the GPU 620 via a D2D or C2C interconnect 624. The CPU 616 can also couple to the GPU 618 and GPU 620 via PCIe interconnects. The CPU 616 can be coupled to one or more NICs or DPUs, which are coupled to one or more networks. For example, as illustrated in FIG. 6, the CPU 616 is coupled to a first NIC/DPU 632, which is coupled to a network 636. The CPU 616 is also coupled to a second NIC/DPU 634, which is coupled to the network 636. The NIC/DPU 632 and NIC/DPU 634 can be coupled to the network 636 over Ethernet (ETH) or InfiniBand (IB) connections.

In at least one embodiment, the processing device 602 and the processing device 604 can communication with each other via a NIC/DPU 638, such as over PCIe interconnects. The processing device 602 and processing device 604 can also communicate with each other over a high-bandwidth communication interconnects 640, such as an NVLink interconnect or other high-speed interconnects.

In at least one embodiment, the computing system 600 is used for high-speed network communication and includes a processing unit (e.g., CPU 606, GPU 608, GPU 610, CPU 616, GPU 618, GPU 620, NIC/DPU 626, NIC/DPU 628, NIC/DPU 632, NIC/DPU 634, or NIC/DPU 638), a memory coupled to the processing unit(s), and a network interface coupled to the processing unit(s) and memory via a link of a communication interface. In various embodiments, one or more of the linked devices can include components described with reference to FIG. 2 for tracking bandwidth utilization and changing link states when threshold criteria are satisfied.

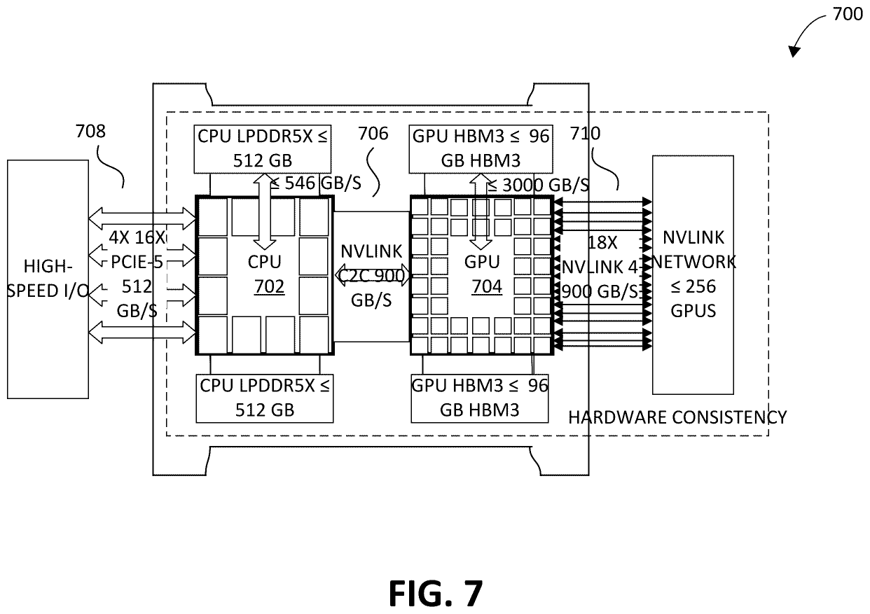

FIG. 7 is a block diagram of a computing system 700 having a CPU 702 and a GPU 704 in a single integrated circuit according to at least one embodiment. The computing system 700 can be a highly integrated design where a CPU 702 and GPU 704 are connected on a single integrated circuit, utilizing an NVLink C2C (Chip-to-Chip) interconnect 706 to enable fast, low-latency communication between the two processing units. This close integration allows for efficient data transfer and parallel processing between the CPU 702 and GPU 704, optimizing performance for complex computational tasks. The GPU elements within the computing system 700 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 710. Additionally, the computing system 700 can be designed to interface with a high-speed I/O through PCIe interconnects 708, ensuring rapid data transfer to and from external devices, further enhancing the system's capabilities in handling data-intensive tasks and providing robust connectivity to peripheral components. It should be noted that the C2C interconnects 706 can be considered D2D interconnects since the CPU 702 and the GPU 704 are located on the same integrated circuit. The integrated circuit can include CPU memory (also referred to as main memory) and GPU memory, which are accessible by the CPU 702 and the GPU 704, respectively, over high-speed interconnects. The computing system 700 can bring together performance of the GPU 704 with the versatility of the CPU 702. The CPU 702 can be connected with a high-bandwidth and memory coherent C2C interconnects 706 in a single integrated circuit. The computing system 700 can support a link switch system.

In at least one embodiment, the computing system 700 is used for high-speed network communication and includes a processing unit (e.g., CPU 702, GPU 704, NVLink network), a memory coupled to the processing unit(s), and a network interface coupled to the processing unit(s) and memory via a link of a communication interface. In various embodiments, one or more of the linked devices can include components described with reference to FIG. 2 for tracking bandwidth utilization and changing link states when threshold criteria are satisfied.

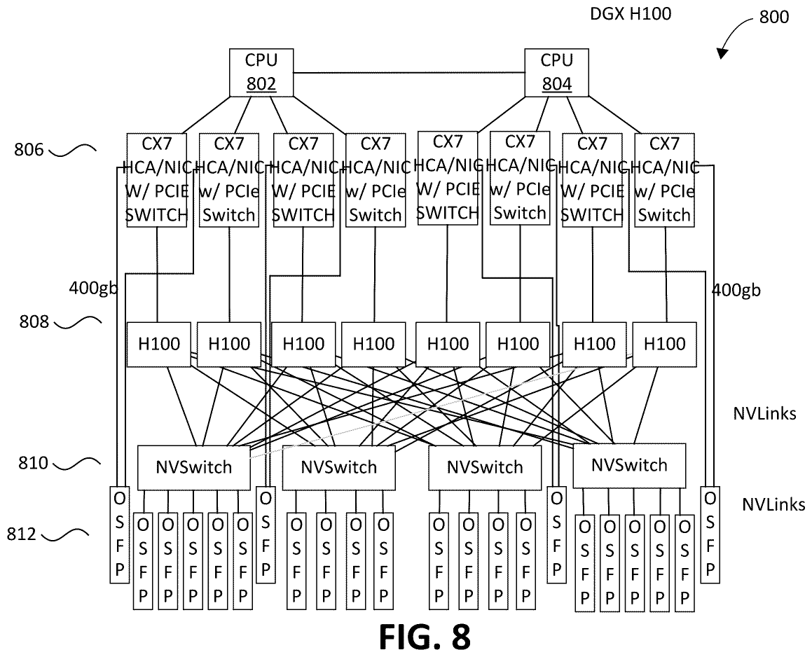

FIG. 8 is a block diagram of a computing system 800 having tensor core GPUs 808 according to at least one embodiment. The computing system 800 can be a DGX H100 system, which is a high-performance computing platform designed to meet the demands of AI, ML, and deep learning (DL) workloads. The computing system 800 can include multiple tensor core GPUs 808 (e.g., NVIDIA H100 Tensor Core GPUs). The tensor core GPUs 808 can each be one of the integrated circuits described above with respect to FIG. 7. The tensor core GPUs 808 can be optimized for AI/ML/DL applications, offering exceptional performance for deep learning training, inference, and high-performance computing tasks. The tensor core GPUs 808 within the computing system 800 are interconnected using high-speed communication interfaces like NVLinks, enabling rapid data transfer between them, which is crucial for handling large-scale AI models and datasets with low latency. This computing system 800 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 808, the computing system 800 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 808 for their specific applications. The computing system 800 is ideally suited for large-scale AI model training, real-time inference, scientific simulations, data analytics, and other compute-intensive tasks that require massive parallel processing power.

The tensor core GPUs 808 can be coupled to multiple CPUs, such as CPU 802 and CPU 804, using switches 806 (e.g., CX7 HCA/NIC with PCIe switch). The tensor core GPUs 808 can be coupled to each other via switches 810 (e.g., NVSwitches). The switches 806 and switches 810 can be coupled to high-speed transceiver modules 812. The high-speed transceiver modules 812 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 800 remains capable of meeting increasing data demands and can be upgraded to support future advancements in network speeds, thus contributing to the system's overall performance and scalability.

In at least one embodiment, the computing system 800 can be considered a data-network configuration with full-bandwidth intra-server NVLinks. In this example, all eight tensor core GPUs 808 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 808 can half-subscribe eighteen NVLinks to GPUs in other servers. Four tensor core GPUs 808 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 808 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 800 is used for high-speed network communication and includes a processing unit (e.g., CPU 802, CPU 802, switches 806, tensor core GPUs 808, switches 810, high-speed transceiver modules 812), and a network interface coupled to the processing unit via a link of a communication interface. In various embodiments, one or more of the linked devices can include components described with reference to FIG. 2 for tracking bandwidth utilization and changing link states when threshold criteria are satisfied.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
determining, by a first device connected to a link of a communication interface, that a bandwidth utilization counter associated with the link satisfies a first threshold criterion of a plurality of threshold criteria, wherein the link is associated with a first bandwidth state; and
sending, to a second device connected to the link, a request to transition the link to a second bandwidth state.

2. The method of claim 1, wherein:
the communication interface is a multi-lane communication interface;
the first bandwidth state corresponds to a first link width; and
the request to transition the link to the second bandwidth state is a request to resize the first link width to a second link width.

3. The method of claim 1, wherein:
the plurality of threshold criteria comprises a second threshold criterion that pertains to a transition from the second bandwidth state to the first bandwidth state;
a difference between the first threshold criterion and the second threshold criterion corresponds to a hysteresis region; and
the bandwidth utilization counter satisfies the first threshold criterion responsive to passing a first threshold value associated with the first threshold criterion subsequent to passing a second threshold value associated with the second threshold criterion.

4. The method of claim 3, further comprising:
determining that the bandwidth utilization counter satisfies a third threshold criterion of the plurality of threshold criteria; and
sending, to the second device, a request to transition the link to a third bandwidth state.

5. The method of claim 1, further comprising:
changing the first threshold criterion to a new threshold criterion based on the second bandwidth state.

6. The method of claim 1, further comprising:
incrementing the bandwidth utilization counter at an increment rate proportional to a data transaction rate associated with the link; and
decrementing the bandwidth utilization counter at a decrement rate proportional to time.

7. The method of claim 6, further comprising:
receiving, by the first device, a set of parameters comprising the first threshold criterion, the first bandwidth state, the second bandwidth state, the increment rate, and the decrement rate.

8. The method of claim 7, wherein the received increment rate is a function of one or more increment parameters, and wherein the received decrement rate is a function of one or more decrement parameters.

9. The method of claim 7, wherein the set of parameters is associated with an application, and wherein the application is one of: a high-performance computing (HPC) application, an artificial intelligence (AI) application, or a gaming application.

10. The method of claim 1, further comprising:
determining, prior to sending the request to transition the link to the second bandwidth state, that the bandwidth utilization counter satisfies the first threshold criterion during a first time period.

11. A system for a first device connected to a link of a communication interface, the system comprising:
a memory; and
one or more processing units, coupled to the memory, to perform operations comprising:
determining that a bandwidth utilization counter associated with the link satisfies a first threshold criterion of a plurality of threshold criteria, wherein the link is associated with a first bandwidth state; and
sending, to a second device connected to the link, a request to transition the link to a second bandwidth state.

12. The system of claim 11, wherein:
the communication interface is a multi-lane communication interface;
the first bandwidth state corresponds to a first link width; and
the request to transition the link to the second bandwidth state is a request to resize the first link width to a second link width.

13. The system of claim 11, wherein:
the plurality of threshold criteria comprises a second threshold criterion that pertains to a transition from the second bandwidth state to the first bandwidth state;
a difference between the first threshold criterion and the second threshold criterion corresponds to a hysteresis region; and
the bandwidth utilization counter satisfies the first threshold criterion responsive to passing a first threshold value associated with the first threshold criterion subsequent to passing a second threshold value associated with the second threshold criterion.

14. The system of claim 13, the operations further comprising:
determining that the bandwidth utilization counter satisfies a third threshold criterion of the plurality of threshold criteria; and
sending, to the second device, a request to transition the link to a third bandwidth state.

15. The system of claim 11, the operations further comprising:
changing the first threshold criterion to a new threshold criterion based on the second bandwidth state.

16. The system of claim 11, the operations further comprising:
incrementing the bandwidth utilization counter at an increment rate proportional to a data transaction rate associated with the link; and
decrementing the bandwidth utilization counter at a decrement rate proportional to time.

17. The system of claim 16, the operations further comprising:
receiving, by the first device, a set of parameters comprising the first threshold criterion, the first bandwidth state, the second bandwidth state, the increment rate, and the decrement rate.

18. The system of claim 17, wherein the received increment rate is a function of one or more increment parameters, and wherein the received decrement rate is a function of one or more decrement parameters.

19. The system of claim 17, wherein the set of parameters is associated with an application, and wherein the application is one of: a high-performance computing (HPC) application, an artificial intelligence (AI) application, or a gaming application.

20. The system of claim 11, the operations further comprising:
determining, prior to sending the request to transition the link to the second bandwidth state, that the bandwidth utilization counter satisfies the first threshold criterion during a first time period.

21. A non-transitory computer-readable medium comprising instructions that, when executed by a processing unit of a first device connected to a link of a communication interface, cause the processing unit to perform operations comprising:
determining that a bandwidth utilization counter associated with the link satisfies a first threshold criterion of a plurality of threshold criteria, wherein the link is associated with a first bandwidth state; and
sending, to a second device connected to the link, a request to transition the link to a second bandwidth state.

22. The non-transitory computer-readable medium of claim 21, wherein:
the communication interface is a multi-lane communication interface;
the first bandwidth state corresponds to a first link width; and
the request to transition the link to the second bandwidth state is a request to resize the first link width to a second link width.

23. The non-transitory computer-readable medium of claim 21, wherein:
the plurality of threshold criteria comprises a second threshold criterion that pertains to a transition from the second bandwidth state to the first bandwidth state;
a difference between the first threshold criterion and the second threshold criterion corresponds to a hysteresis region; and
the bandwidth utilization counter satisfies the first threshold criterion responsive to passing a first threshold value associated with the first threshold criterion subsequent to passing a second threshold value associated with the second threshold criterion.

24. The non-transitory computer-readable medium of claim 23, the operations further comprising:
determining that the bandwidth utilization counter satisfies a third threshold criterion of the plurality of threshold criteria; and
sending, to the second device, a request to transition the link to a third bandwidth state.

25. A system for high-speed network communication in a data center, the system comprising:
one or more processing units;
a memory coupled to the one or more processing units; and
a network interface coupled to the one or more processing units and the memory via a link of a communication interface, wherein the network interface is to perform operations comprising:
determining that a bandwidth utilization counter associated with the link satisfies a first threshold criterion of a plurality of threshold criteria, wherein the link is associated with a first bandwidth state; and
sending, to the one or more processing units, a request to transition the link to a second bandwidth state.

26. The system of claim 25, wherein:
the communication interface is a multi-lane communication interface;
the first bandwidth state corresponds to a first link width; and
the request to transition the link to the second bandwidth state is a request to resize the first link width to a second link width.

27. The system of claim 25, wherein:
the plurality of threshold criteria comprises a second threshold criterion that pertains to a transition from the second bandwidth state to the first bandwidth state;
a difference between the first threshold criterion and the second threshold criterion corresponds to a hysteresis region; and
the bandwidth utilization counter satisfies the first threshold criterion responsive to passing a first threshold value associated with the first threshold criterion subsequent to passing a second threshold value associated with the second threshold criterion.
